(19) United States
(12) Patent Application Publication
(10) Pub. No.: US 2012/0275075 A1
(43) Pub. Date: Nov. 1, 2012

(54) Electrostatic Discharge Protection Device

(75) Inventors: Alexandre Dray, Crolles (FR); Philippe Galy, Le Touvet (FR); Johan Bourgeat, Allevard (FR)

(73) Assignee: STMicroelectronics SA, Montrouge (FR)

(21) Appl. No.: 13/456,918

(22) Filed: Apr. 26, 2012

(30) Foreign Application Priority Data
Apr. 27, 2011 (FR) 1153589
Apr. 10, 2012 (FR) 1253262

(51) Int. Cl. H02H 9/04

(52) U.S. Cl. 361/56

(57) ABSTRACT

Semiconducting device for protecting at least one node of an integrated circuit against electrostatic discharges, comprising a doublet of floating gate thyristors connected in parallel and head-to-foot, the two thyristors having respectively two distinct gates and a common gate formed by a common semiconducting layer, the anode of a first thyristor of the doublet and the cathode of the second thyristor of the doublet forming a first terminal of the doublet designed to be connected to a cold point and the cathode of the first thyristor of the doublet and the anode of the second thyristor of the doublet forming a second terminal of the doublet designed to be connected to the said node to be protected.

This application claims priority to French National patent application Ser. No. 11/53589, which was filed Apr. 27, 2011 and withdrawn on Mar. 29, 2012, and which is incorporated herein by reference to the fullest extent allowed by law, and claims priority to French National patent application Ser. No. 12/53262, which was filed Apr. 10, 2012, and which is incorporated herein by reference to the fullest extent allowed by law.

### TECHNICAL FIELD

The present invention relates generally to integrated circuits and more particularly to the protection of these integrated circuits against electrostatic discharges and notably those of the “charged-device model” type known to those skilled in the art by the acronym CDM.

### BACKGROUND

In the microelectronics field, an electrostatic discharge may occur throughout the life of an integrated circuit and constitutes a real problem for the reliability of this integrated circuit and a major cause of failure.

In order to define the ESD robustness of an integrated circuit against electrostatic discharges, it is possible to carry out various tests which obey different models. It is possible notably to cite the HBM (Human Body Model), MM (Machine Model) and CDM (Charged-Device Model) tests.

The HBM test corresponds to the discharge current generated by a person that touches with his finger a device connected to ground. The electric circuit used to simulate this type of discharge conventionally comprises a capacitor, typically of 100 picofarads, in series with a resistor typically of 1500 ohms, the circuit being connected to the device under test. The capacitor is then charged to a voltage of the order of a few kilovolts. The corresponding ESD pulse corresponds to a current pulse the average duration of which is 300 nanoseconds with a current peak varying between 1 and 3 amperes depending on the value of the pre-charge voltage.

The MM model corresponds to an ESD discharge that would be produced by a machine touching the device or a person handling a metal tool touching the device. The MM model is substantially the same as the HBM model but with different capacitor and resistor values.

The CDM model differs from the HBM and MM models and is used to simulate a charged device that discharges through at least one of its pins contacting for example a ground plane. Such an ESD discharge then takes the form of a current pulse of great amplitude (typically 15 amperes) for an extremely short period, typically one nanosecond.

Elements of an integrated circuit that are particularly sensitive to ESD pulses of the HBM or MM type are notably the input/output ports and the circuitry on the periphery of the integrated circuit. On the other hand, the charges resulting from an ESD pulse of the CDM type do not necessarily follow the input/output paths to discharge but may follow any path inside the device in order to discharge to a single contact point.

It is therefore necessary, in order to ensure a good robustness of a device against ESD discharges of the CDM type, to protect nodes inside the integrated circuit, in particular nodes common to different domains of the integrated circuit, for example a digital domain and an analogue domain, likely to be powered with different power-supply voltages.

The current solution consists in using an individual protective element for each node or connection to be protected. Usually, this protective element conventionally comprises an NMOS transistor the gate of which is connected to ground (GG NMOS: “grounded gate NMOS”) associated with a diode. However, the use of such a local protective element for each node or connection to be protected rapidly leads to considerable footprint when the number of nodes to be protected is great.

### SUMMARY OF THE INVENTION

In one aspect, embodiments of the invention provide for a semiconducting device for protecting at least one node of an integrated circuit against electrostatic discharges, comprising a doublet of floating-gate thyristors connected in parallel and head-to-foot. The doublet includes a first and a second thyristor having respectively two distinct gates and a common gate formed by a common semiconducting layer. An anode of a first thyristor of the doublet and a cathode of the second thyristor of the doublet form a first terminal of the doublet configured to be connected to a cold point, and a cathode of the first thyristor of the doublet and an anode of the second thyristor of the doublet form a second terminal of the doublet configured to be connected to said node to be protected.

In another aspect, embodiments of the invention provide for an integrated circuit comprising a first node, a ground node, and a doublet. The doublet includes a first thyristor having a first floating gate, a second thyristor having a second floating gate, and being connected in a parallel and head-to-foot orientation with the first thyristor, and a common gate shared by the first and second thyristors. An anode of the first thyristor and a cathode of the second thyristor form a first terminal of the doublet, and a cathode of the first thyristor and an anode of the second thyristor form a second terminal of the doublet. The first terminal of the doublet is coupled to the first node and the second terminal of the doublet is coupled to the ground node.

In yet another aspect, embodiments of the invention provide for an integrated circuit comprising a first domain having a plurality of first nodes and a first ground node, a second domain having a plurality of second nodes and a second ground node, and an electrostatic discharge device including a first plurality of doublets, each doublet of the first plurality of doublets having a first terminal coupled to a respective one of the first plurality of nodes of the first domain and a second terminal coupled to a common node. The electrostatic discharge device includes a second plurality of doublets, each doublet of the second plurality of doublets having a first terminal coupled to a respective one of the second plurality of nodes of the second domain and a second terminal coupled to the common node.

### BRIEF DESCRIPTION OF THE DRAWINGS

For a more complete understanding of the present invention, and the advantages thereof, reference is now made to the following descriptions taken in conjunction with the accompanying drawing, in which:

FIGS. 1 and 2 illustrate schematically a first embodiment of a device according to the invention;

FIGS. 3 and 4 illustrate schematically a second embodiment of a device according to the invention;

FIGS. 5 and 6 illustrate schematically a third embodiment of a device according to the invention;

FIGS. 7 and 8 illustrate schematically a fourth embodiment of a device according to the invention; and

FIG. 9 illustrates schematically an example of an integrated circuit incorporating an example of a device according to the invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention. Before describing the illustrated embodiments in detail, various embodiments and advantageous features thereof will be discussed general in the following paragraphs.

According to one embodiment, a particularly compact device is proposed for protecting against electrostatic discharges, which device may be used for the protection of all types of ESD pulses, but which is of particular value for the protection of ESD pulses of the CDM type when many internal connections or nodes in the integrated circuit have to be protected.

According to one aspect, a semiconducting device is proposed for protecting at least one node of an integrated circuit against electrostatic discharges, the device comprising a doublet of floating-gate thyristors connected in parallel and head-to-foot, the two thyristors having respectively two distinct gates and a common gate, formed by a common semiconducting layer, the anode of a first thyristor of the doublet and the cathode of the second thyristor of the doublet forming a first terminal of the doublet designed to be connected to a cold point, for example the ground, and the cathode of the first thyristor of the doublet and the anode of the second thyristor of the doublet forming a second terminal of the doublet designed to be connected to the node to be protected.

The two thyristors mounted head-to-foot make it possible to have a two-way protective device. Moreover, the common gate formed by a common semiconducting layer makes it possible to have a compact device.

It is not necessary to have an external trigger element to trigger the device. Specifically, simply applying a potential to the anode or the cathode of a thyristor leads to a thermodynamic imbalance of the device and a distribution of the potential over the whole device, which leads to biasing of the junctions allowing an injection of minority or majority carriers depending on the case, which leads to placing the bipolar transistors of the device in conduction with, when the product of the gains in current of both transistors of each thyristor is greater than 1, an amplification, maintained by a positive feedback, of the base currents of the transistors until obtaining an operation of those transistors in a saturated mode.

According to one embodiment, the semiconducting layer has a first type of conductivity, for example N type, and the doublet comprises two first semiconducting zones having the first type of conductivity, for example N+ doped zones. Each first semiconducting zone is in contact with a semiconducting well having a second type of conductivity, for example P type, opposite to the first type. The two wells form respectively the two distinct gates of the two thyristors and are mutually separated and in contact with the common semiconducting layer. The device also comprises two second semiconducting zones having the second type of conductivity, for example P+ doped zones, which are in contact with the common semiconducting layer. Each second zone preferably surrounds a first zone (which makes it possible to have a larger second zone and makes it easier to make a second zone common to several doublets), and two electrical connections are provided between, respectively, the two first semiconducting zones and the two second semiconducting zones surrounding these two first semiconducting zones. The two pairs of mutually electrically connected first semiconducting zones and second semiconducting zones form respectively the two terminals of the doublet.

When several nodes of an integrated circuit are to be protected against electrostatic discharge, the device comprises, according to one embodiment, at least one group of several doublets of floating-gate thyristors, all the thyristors having a common gate formed by the common semiconducting layer, and the first terminals of all the doublets are mutually connected to form a first terminal of the device designed to be connected to the cold point and the second terminals of the doublets form respectively several second terminals of the device designed to be respectively connected to the several nodes to be protected.

So as to make the device yet more compact, all the doublets preferably comprise in common a first semiconducting zone, the corresponding well and the corresponding second semiconducting zone connected to this first semiconducting zone. In this case, the first terminal of the device then comprises the first and second common semiconducting zones.

According to another embodiment making it possible to obtain a device for protecting several nodes while providing a yet more compact structure, provision is made for the doublets to be arranged in a network with each second zone surrounding the corresponding first zone to which it is connected. The second terminals of the device comprise respectively the first semiconducting zones of the different doublets of the first common semiconducting zone, all these different first semiconducting zones of the first common semiconducting zone being adjacent to the second common semiconducting zone surrounding the first common semiconducting zone.

As a non-limiting example, the network may be a matrix network comprising lines and columns of first semiconducting zones, for example a 3×3 matrix, the first common semiconducting zone being placed in the center of the matrix.

According to another aspect, an integrated circuit is proposed that comprises at least one device as defined above, connected to at least one node of the integrated circuit. According to one embodiment, the integrated circuit comprises a device of which the second terminals are respectively connected to different nodes of the integrated circuit and of which the first terminal is connected to the cold point.

According to another embodiment in which the integrated circuit comprises at least two domains designed to be powered by different power supply voltages, at least one device is provided in which the second terminals are respectively connected to different nodes common to the said domains.

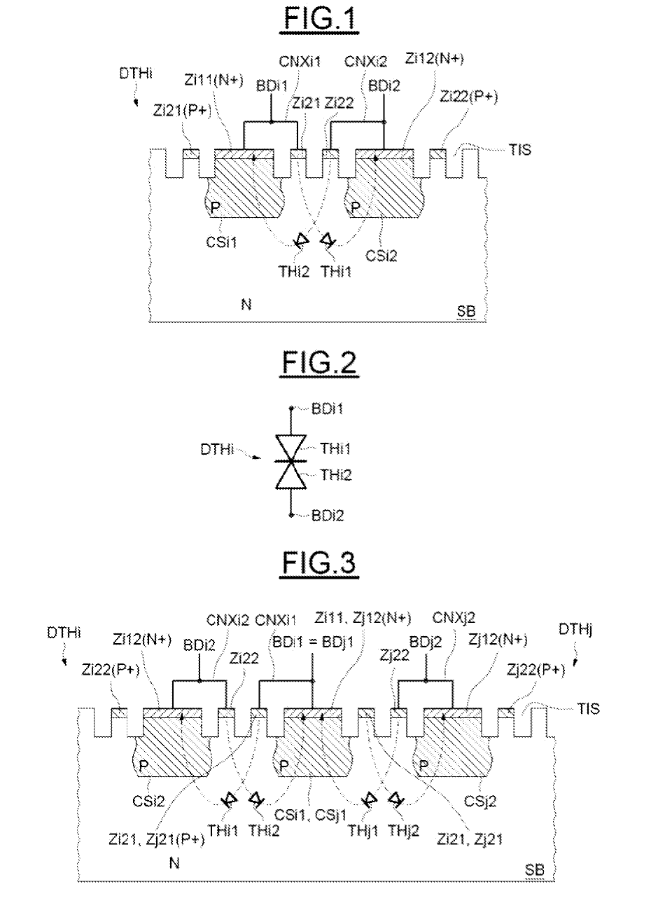

Turning now to the illustrated embodiments, in FIGS. 1 and 2, the reference DTHi designates a doublet of two thyristors THi1 and THi2 connected in parallel and mounted head-to-foot so as to form a triac of which the gates of the two thyristors are floating.

More precisely, as illustrated in FIG. 1, the device comprises a common semiconducting layer SB having in this instance the N type of conductivity. This layer may be a bulk substrate N or else an N-type well implanted in a bulk P-type substrate, or else a substrate on insulator (SOI: “Silicon On Insulator”).

The doublet DTHi of thyristors is formed in and on top of the semiconducting layer SB. More precisely, two wells CSi, having P type conductivity, are produced in the layer SB, for example by implantation. These two wells are mutually spaced apart from one another, as shown.

In contact with the two wells CSi1 and CSi2, two first semiconducting zones Zi11 and Zi12 are respectively produced by implantation, these two first zones being N+ doped in the illustrated example. Moreover, a second semiconducting zone Zi21, P+ doped, and also produced by implantation in the layer SB, surrounds the first semiconducting zone Zi11 and is electrically isolated from this zone Zi11 by an isolating trench TIS. Similarly, a second semiconducting zone Zi22, also P+ doped, surrounds the first semiconducting zone Zi12 and is isolated from the latter by an isolating trench TIS.

An electrical connection CNXi1, for example a metallization of the first metal level (metal M1) of the integrated circuit, electrically connects the first semiconducting zone Zi11 and the second semiconducting zone Zi21 on top of the layer SB. Similarly, an electrical connection CNXi2 (also at the metal level M1 for example) connects the first semiconducting zone Zi12 and the second semiconducting zone Zi22 It can therefore be seen that the doublet DTHi comprises a first thyristor THi1 of the PNPN type.

More precisely, the P anode of the thyristor THi1 is formed by the second semiconducting zone Zi21 and the cathode of this thyristor is formed by the first semiconducting zone Zi12. The thyristor comprises an N gate and a P gate. The N gate is formed by the layer SB while the P gate is formed by the well CSi2.

The second thyristor THi2 is also of the PNPN type. Its anode is formed by the second semiconducting zone Zi22, and its cathode by the first semiconducting zone Zi11. The second thyristor also has an N gate and a P gate. The N gate of the thyristor THi2 is also formed by the layer SB and is therefore common with the N gate of the thyristor THi1. The P gate of the thyristor THi2 is formed by the well CSi1 and is distinct from the P gate of the thyristor THi1.

By the electrical connections CNXi1 and CNXi2, the anode of the thyristor THi1 is electrically connected to the cathode of the thyristor THi2 and the anode of the thyristor THi2 is electrically connected to the cathode of the thyristor THi1.

A first terminal BDi1 of the thyristor doublet DTHi is formed by the anode of the thyristor THi1 and the cathode of the thyristor THi2. The second terminal BDi2 of the doublet DTHi is formed by the anode of the thyristor THi2 and the cathode of the thyristor THi1.

The first terminal BDi1 is for example designed to be connected to a cold point, for example the ground, while the second terminal BDi2 is designed to be connected to the node to be protected.

If the second terminal BDi2, and consequently the anode of the thyristor THi2, is brought to a positive potential relative to ground, a thermodynamic imbalance is then created in the thyristor which causes a distribution of the potential over the whole thyristor, leading to biasing of the PN junctions and consequently allowing an injection of minority carriers (in this instance the electrons), which results in placing the bipolar transistors of the thyristor in conduction.

If a negative potential relative to ground is applied to the terminal BDi2, and consequently to the cathode of the thyristor THi1, there is also a distribution of potential over the whole of the thyristor THi1 which leads to biasing of the junctions and allowing an injection of minority carriers (in this instance the holes), which leads to placing the bipolar transistors of the thyristor THi1 in conduction.

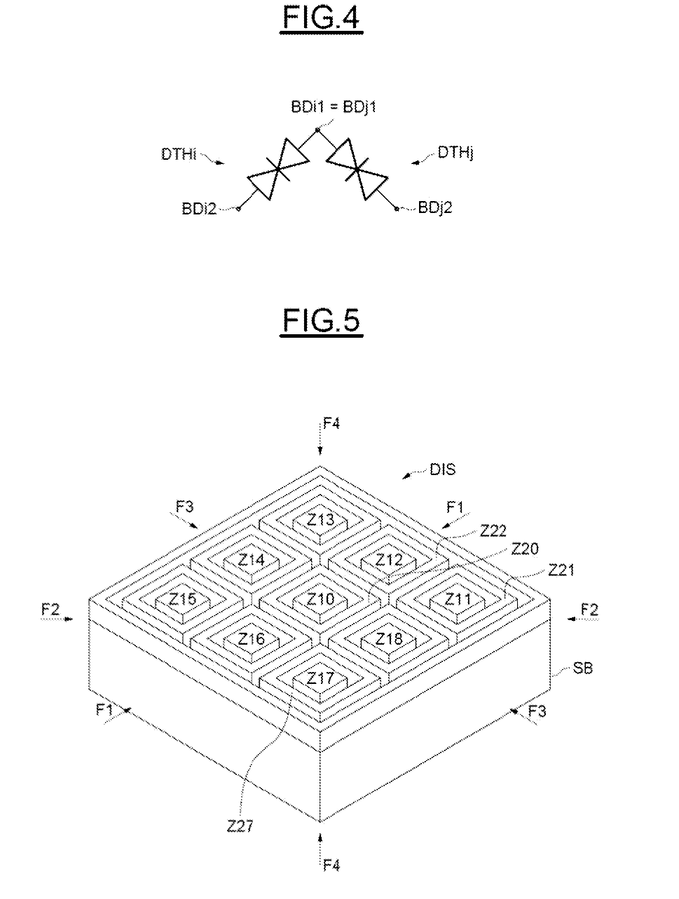

More precisely, in the one or other one of the cases, taking into account of the structure of a thyristor with two looped-coupled transistors, injecting charges in the base of one of the transistor leads, when the product of the gains in current (β gains) of both transistors is greater than 1, in obtaining a kept alive positive feedback loop, causing an amplification of the base current injected in each transistor of the thyristor and leading to an operation of the transistors of the thyristor in a saturated mode. The embodiment illustrated in FIGS. 3 and 4 illustrates the configuration in which there are two doublets DTHi and DTHj of thyristors having a common terminal, in this case the terminal BDi1 of the doublet DTHi and the terminal BDj1 of the doublet DTHj.

In this respect, the first semiconducting zone Zi11, Zj11 of each doublet is common to the two doublets, like the corresponding well CSi1, CSj1 and the second semiconducting zone Zi21, Zj21 surrounding the first common semiconducting zone Zi11, Zj11.

It can therefore be seen that the two thyristors THj1 and THj2 of the doublet DTHj are connected in parallel and head-to-foot with their floating gates. Moreover, the two thyristors THi1 and THi2 of the doublet DTHi are also connected head-to-foot in parallel with their floating gates. The N-gates of all the thyristors are common and formed by the layer SB. Moreover, the anode of the thyristor THj2 is electrically connected to the anode of the thyristor THi1 by means of the connection CNXi1 in order to form the common terminal BDi1, BDj1.

The device of FIG. 3 and of FIG. 4 therefore makes it possible to protect two nodes that will be respectively connected to the terminals DBi2 and BDj2 of the device while the common terminal BDi1, BDj1 is designed to be connected to ground.

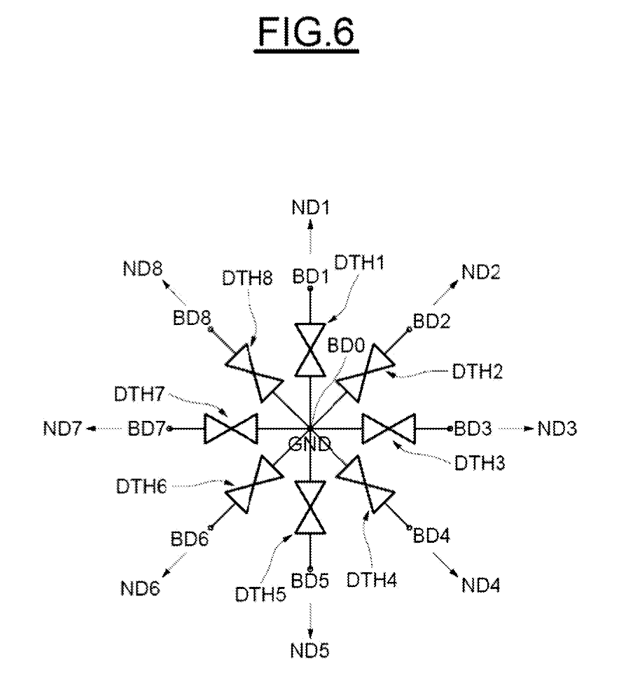

The device illustrated in FIGS. 5 and 6 is used to protect eight nodes ND1-ND8 of an integrated circuit against ESD pulses. It comprises a particularly compact structure of eight doublets DTH1-DTH8 of thyristors arranged in a matrix network (FIG. 5) comprising in this instance three lines and three columns of first semiconducting zones Z1k respectively surrounded by their corresponding second semiconducting zones Z2k to which they are respectively electrically connected by metallization.

More precisely, the first central semiconducting zone Z10, surrounded by the corresponding second semiconducting zone Z20 and placed in contact with the corresponding underlying well, are common to all the thyristors, and the first central semiconducting zone Z10 electrically connected to the second zone Z20 forms the first terminal BD0 of the device DIS designed to be connected to ground GND as indicated in FIG. 6.

The other first semiconducting zones Z11-Z18 surrounded by their second zones Z21-Z28 and situated immediately adjacent to the common second central zone Z20 form respectively the second terminals BD1-BD8 of the device and are respectively designed to be connected to the nodes to be protected ND1-ND8.

Such a device makes it possible to protect eight nodes and occupies three times less space on the silicon than a device of the prior art comprising eight local protections each formed by a diode and a GGNMOS transistor. This being so, the platform of FIG. 5 would also allow the protection of a number of nodes that is less than 8, for example 3 nodes respectively connected to the zones Z11, Z10 and Z13, the zone Z12 then being connected to ground GND, or else 5 nodes if two additional nodes are connected to the zones Z14 and Z18. In any case, the first zones Z1 connected to the nodes to be protected are adjacent (in the directions F1, F2, F3 or F4) to the first zone which is connected to ground and which then forms the first zone common to these doublets.

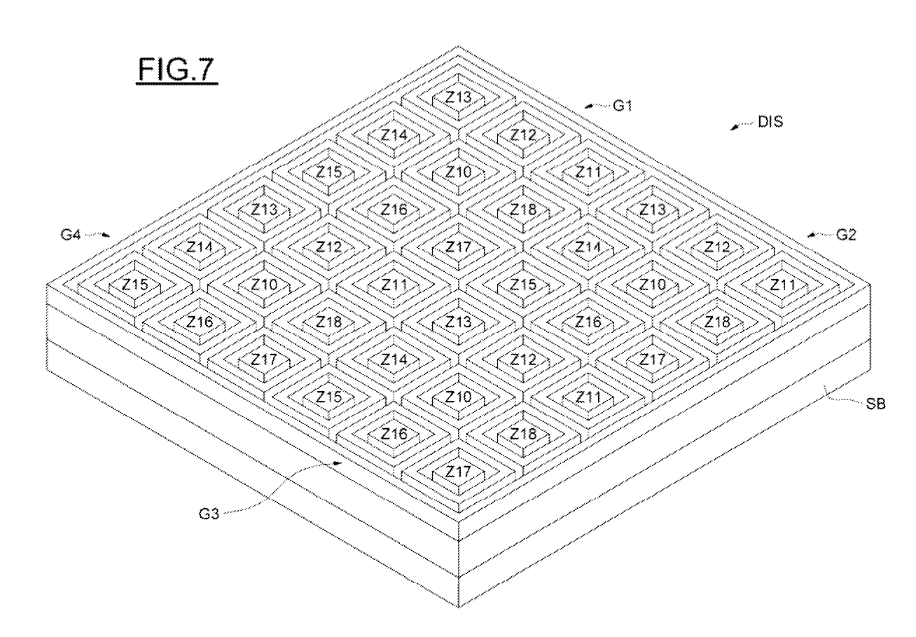

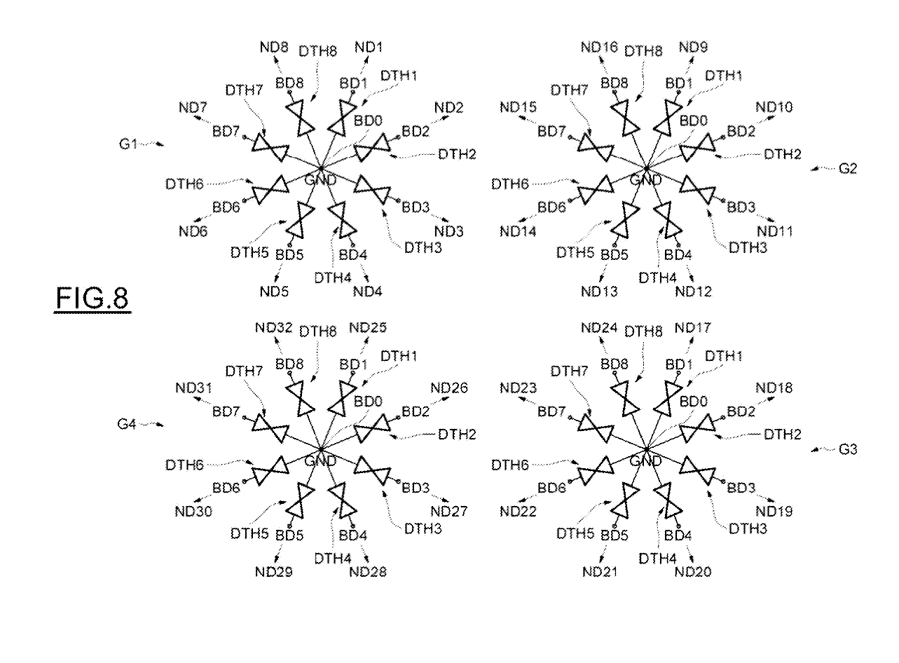

It would also possible, as illustrated in FIG. 7, to provide a device or platform DIS comprising four identical groups G1-G4 each comprising a 3×3 matrix like that illustrated in FIG. 5. In this case, it is possible to protect, as illustrated in FIG. 8, 32 nodes ND1-ND32. In this respect, the first central zone Z10 of each group of eight doublets of thyristors is connected to ground, and eight nodes are connected to the other eight zones of each group Gi. Naturally, other types of network arrangement are possible, such as for example a hexagonal, octagonal, etc. network.

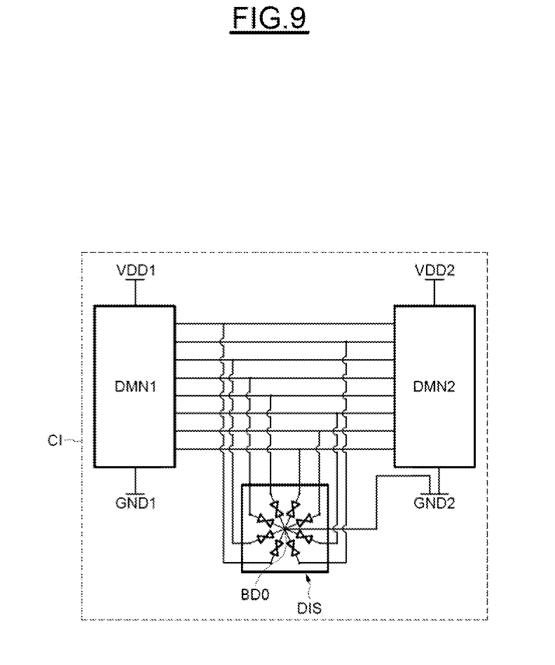

As illustrated in FIG. 9, a device according to the invention is particularly suitable for protecting nodes internal to an integrated circuit and common to two domains DMN1 and DMN2, for example analogue and digital domains, respectively powered by different power-supply voltages VDD1 and VDD2 and having different grounds GND1, GND2.

The first terminal BD0 of the device is then connected to ground GND2 of the domain to be protected more specifically (in this instance the domain DMN2) while the second terminals of the device are respectively connected to the nodes to be protected.

The invention therefore makes it possible to obtain a very good level of protection against electrostatic discharges, notably of the CDM type, with a smaller footprint relative to an equivalent protection of the prior art. The proposed structure, notably via its matrix approach, provides a protective platform that is extendable and modulatable. The proposed protective device is independent of the fabrication technology and can be applied notably to all BICMOS technologies, and in particular SOI technologies.

The preferred embodiment device provides protection with a very low leakage current because it comprises only PN junctions and no MOS transistors, such as in the illustrated examples. The device also has a low capacitive value and is compatible with the architectures of standard cells.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A semiconducting device for protecting at least one node of an integrated circuit against electrostatic discharges, comprising:
a doublet of floating-gate thyristors connected in parallel and head-to-foot, doublet being a first and a second thyristor having respectively two distinct gates and a common gate formed by a common semiconducting layer;
an anode of a first thyristor of the doublet and a cathode of the second thyristor of the doublet forming a first terminal of the doublet configured to be connected to a cold point; and
a cathode of the first thyristor of the doublet and an anode of the second thyristor of the doublet forming a second terminal of the doublet configured to be connected to said node to be protected.

2. The device according to claim 1, in which said common semiconducting layer has a first type of conductivity, and wherein the doublet comprises:
two first semiconducting zones each having the first type of conductivity, each first semiconducting zone being in contact with a respective semiconducting well having a second type of conductivity opposite to the first type, the two wells forming respectively said two distinct gates and being mutually separated from one another, and in contact with said common semiconducting layer,
two second semiconducting zones having the second type of conductivity and being in contact with said common semiconducting layer, and
two electrical connections between respectively the two first semiconducting zones and the two second semiconducting zones, the two pairs of mutually electrically connected first semiconducting zones and second semiconducting zones forming two terminals of the doublet.

3. The device according to claim 2, in which each second semiconductor zone surrounds the first zone to which it is electrically connected.

4. The device according to claim 1, comprising at least one group of a plurality of doublets of floating-gate thyristors, the plurality of doublets having a common gate formed by said common semiconducting layer, respective first terminals of all the plurality of doublets being mutually connected to form a first terminal configured to be connected to said cold point and respective second terminals of the plurality of doublets forming respectively a plurality of second terminals configured to be respectively connected to a plurality of respective nodes to be protected.

5. The device according to claim 4, in which said plurality of doublets comprise in common a first common semiconducting zone, a corresponding common well and a corresponding common second semiconducting zone connected to the first common semiconducting zone, said first terminal comprising said first common semiconducting zone and said second common semiconducting zone.

6. The device according to claim 5, in which the doublets are arranged in a network having a common zone, and the second terminals comprise respectively the first semiconducting zones of the doublets within the common zone, the respective first semiconducting zones of the doublets within the common zone being adjacent to a second common semiconducting zone surrounding the first common semiconducting zones.

7. The device according to claim 6, in which the network is a matrix network comprising lines and columns of first semiconducting zones, said first common semiconducting zone being placed in the center of the matrix.

8. The device according to claim 2, wherein the product of the gains in current of both transistors of each thyristor is greater than one.

9. An integrated circuit comprising
a first node;
a ground node;
a doublet comprising:
a first thyristor having a first floating gate;
a second thyristor having a second floating gate, and being connected in a parallel and head-to-foot orientation with the first thyristor;
a common gate shared by the first and second thyristors;
an anode of the first thyristor and a cathode of the second thyristor forming a first terminal of the doublet;
a cathode of the first thyristor and an anode of the second thyristor forming a second terminal of the doublet; wherein
the first terminal of the doublet is coupled to the first node and the second terminal of the doublet is coupled to the ground node.

10. The integrated circuit according to claim 9 comprising a plurality of doublets, wherein each double comprises:
two first semiconducting zones each having a first type of conductivity, each first semiconducting zone being in contact with a respective semiconducting well having a second type of conductivity opposite to the first type, the two wells forming respectively two distinct gates and being mutually separated from one another, and in contact with a common semiconducting layer,
two second semiconducting zones having the second type of conductivity and being in contact with said common semiconducting layer, and
two electrical connections between respectively the two first semiconducting zones and the two second semiconducting zones, the two pairs of mutually electrically connected first semiconducting zones and second semiconducting zones forming the two terminals of the doublet.

11. The integrated circuit of claim 10 wherein:
said plurality of doublets comprise in common a first common semiconducting zone, a corresponding common well and a corresponding common second semiconducting zone connected to the first common semiconducting zone, said first terminal comprising said first common semiconducting zone and said second common semiconducting zone; and
the doublets are arranged in a network having a common zone, and the second terminals comprise respectively the first semiconducting zones of the doublets within the common zone, the respective first semiconducting zones of the doublets within the common zone being adjacent to a second common semiconducting zone surrounding the first common semiconducting zones.

12. The integrated circuit of claim 11, in which the second terminals of the plurality of doublets are respectively connected to different nodes of the integrated circuit and in which the respective first terminals of the plurality of doublets are each connected to the ground node.

13. The integrated circuit according to claim 10, comprising at least two domains configured to be powered by different power supply voltages, wherein a first terminal of a first one the plurality of doublets is coupled to a node of a first domain, a first terminal of a second one of the plurality of doublets is coupled to a node of the second domain, and a second terminal of the first one of the plurality of doublets and a second terminal of the second one of the plurality of doublets is coupled to a node common to the first and second domains.

14. An integrated circuit comprising:
a first domain having a plurality of first nodes and a first ground node;
a second domain having a plurality of second nodes and a second ground node;
an electrostatic discharge device including a first plurality of doublets, each doublet of the first plurality of doublets having a first terminal coupled to a respective one of the first plurality of nodes of the first domain and a second terminal coupled to a common node, the electrostatic discharge device including a second plurality of doublets, each doublet of the second plurality of doublets having a first terminal coupled to a respective one of the second plurality of nodes of the second domain and a second terminal coupled to the common node.

15. The integrated circuit of claim 14, wherein the common node is coupled to at least one of the first ground node and the second ground node.

16. The integrated circuit of claim 14, wherein each doublet comprises:
a first thyristor having a floating gate, a cathode connected to the first terminal of the doublet, and an anode connected to the second terminal of the doublet; and
a second thyristor having a floating gate, an anode connected to the first terminal of the doublet, and a cathode connected to the second terminal of the doublet; and
a common gate common to the first thyristor and the second thyristor.

17. The integrated circuit of claim 16 wherein each doublet further comprises:
the first thyristor including having a semiconductor layer having a first conductivity type, a first well formed in the semiconductor layer and having a second conductivity type, a first semiconducting zone formed in the first well and having the first conductivity type, and a second semiconducting zone having the second conductivity type, the second semiconducting zone being formed in the semiconductor layer and surrounding but electrically isolated from the first semiconducting zone;
the second thyristor including the semiconductor layer, a second well formed in the semiconductor layer and having the second conductivity type, another first semiconducting zone formed in the second well and having the first conductivity type, and another second semiconducting zone having the second conductivity type, the another second semiconducting zone being formed in the semiconductor layer and surrounding but electrically isolated from the another first semiconducting zone;
a first electrical connection between the first semiconducting zone and the another second semiconducting zone; and
a second electrical connection between the second semiconducting zone and the another first semiconducting zone.

18. The integrated circuit of claim 17 wherein the first plurality of doublets and the second plurality of doublets are formed in a matrix and wherein:
each doublet in the matrix shares a common semiconductor layer, first well, and first semiconducting zone.

19. The integrated circuit of claim 18 wherein the matrix comprises nine doublets.

20. The integrated circuit of claim 18 wherein the integrated circuit comprises a plurality of matrices.

21. The integrated circuit of claim 20 wherein each matrix couples a plurality of individual nodes of the integrated circuit to a common ground node via respective doublets.
